(19) United States
(12) Patent Application Publication
(10) Pub. No.: US 2023/0347830 A1
(43) Pub. Date: Nov. 2, 2023

(54) Device for Lifting an Object Onto the Roof of a Vehicle

(71) Applicant: Gittens Pty Ltd, Mornington (AU)

(72) Inventor: Martyn Gittens, Mornington (AU)

(21) Appl. No.: 17/629,748

(22) PCT Filed: Jul. 22, 2020
(86) PCT No.: PCT/AU2020/050751

§ 371 Date: Jan. 24, 2022

(30) Foreign Application Priority Data
Jul. 23, 2019 (AU) 2019902604

(51) Int. Cl. B60R 9/042; B60P 3/10

(52) U.S. Cl. CPC B60R 9/042; B60P 3/1016

(57) ABSTRACT

A device for lifting an object onto the roof of a vehicle, the device comprising: a vertical bar connected to a tow-hitch bar on the vehicle; a cross bar connected to the vertical bar; and support bar connected to the cross bar for loading the object onto the roof of the vehicle, wherein the device has a pivoting joint between the vertical bar and the cross bar.

### TECHNICAL FIELD

The present invention relates to lifting devices and, more particularly, to a device to load a kayak on top of a vehicle.

### BACKGROUND

Lifting devices are available to assist people to load kayaks onto the roofs of their vehicles in order to transport the kayak to and from water sport locations.

FIGS. 1 and 2 shows a prior art lifting device 10 supporting a kayak 16 on top of a vehicle 14. The device 10 is attached to the tow bar receiver 12 of a vehicle 14. The lifting device 10 can be tilted so to allow a user 11 to lift the kayak 16 onto the device 10 and thereby onto the top of the vehicle 14.

A significant problem with the prior art device shown in FIGS. 1 and 2 is that even though the device 10 can be tilted, it is still exceedingly difficult to lift the front of the kayak 16 to a height sufficient to for the kayak 16 to rest on the device 10. This is the case even for young, fit people, as kayaks are often heavy and weigh about thirty-five kilograms on average.

The object of the present invention is to provide a lifting device which requires less effort to mount and dismount a kayak on the roof of a vehicle than prior art lifting devices.

### SUMMARY OF THE INVENTION

According to the present invention, there is provided a device for lifting an object onto the roof of a vehicle, the device comprising:
(a) a vertical bar connected to a tow-hitch bar on the vehicle;
(b) a cross bar connected to the vertical bar; and
(c) support bar connected to the cross bar for loading the object onto the roof of the vehicle,
   wherein the device has a pivoting joint between the vertical bar and the cross bar.

Preferably, the pivoting joint is an adjustable ratchet cam, but the pivoting joint may include any type of manual or automatic rotation angle locking mechanism. For example, the pivoting joint may include an electrically powered gear to automatically rotate the pivoting joint, a ratchet and pin system or any other form of locking mechanism.

The ratchet cam may have a pin which interfaces with teeth on the cam to lock the cam into one or more positions. The pin may be released by a lever connected to the pin. It is preferred that the lever is attached to a cable adapted to be pulled to release the pin. In alternate embodiments of the invention, the ratchet cam may be released by a lever which is adapted to be pushed by the object as it passes over the support bar.

The device preferably has a strut between the tow-hitch bar and the cross bar to support the weight of the object as it is raised and lowered on the support bar. The support bar may be adapted to pivot on a joint with the cross bar.

Any of the features described herein can be combined in any combination with any one or more of the other features described herein within the scope of the invention.

### BRIEF DESCRIPTION OF DRAWINGS

An embodiment of the invention will be described with reference to the following drawings, in which:

FIG. 1 is a perspective view of a kayak on a vehicle supported by a prior art lifting device.

FIG. 2 is perspective view of a user awkwardly mounting the kayak on the prior art lifting device of FIG. 1.

FIG. 3 is a perspective view of the user easily mounting the kayak on the lifting device of the present invention.

FIG. 4 is a perspective view of the lifting device of FIG. 3 (in an upright position) mounted on the vehicle.

FIG. 5 is a perspective view of the lifting device of FIG. 3 in isolation.

FIG. 6 is a perspective close-up view of the pivoting joint of the lifting device of FIG. 3.

FIG. 7 is a perspective close-up view of the first ratchet lever for the pivoting joint of the lifting device of FIG. 3.

### DETAILED DESCRIPTION

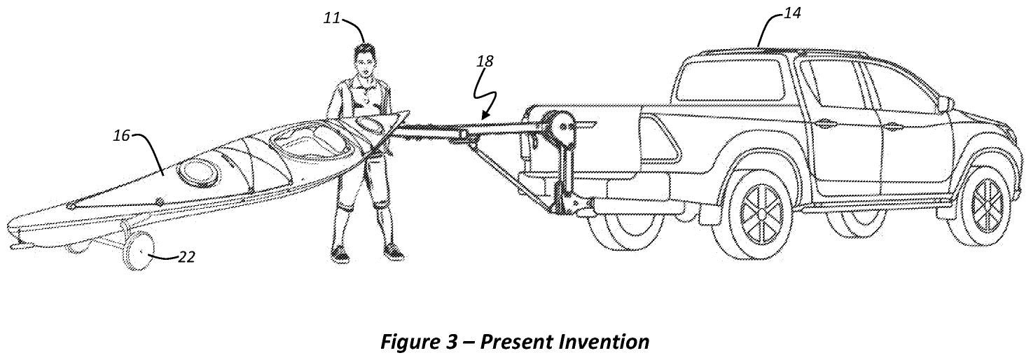

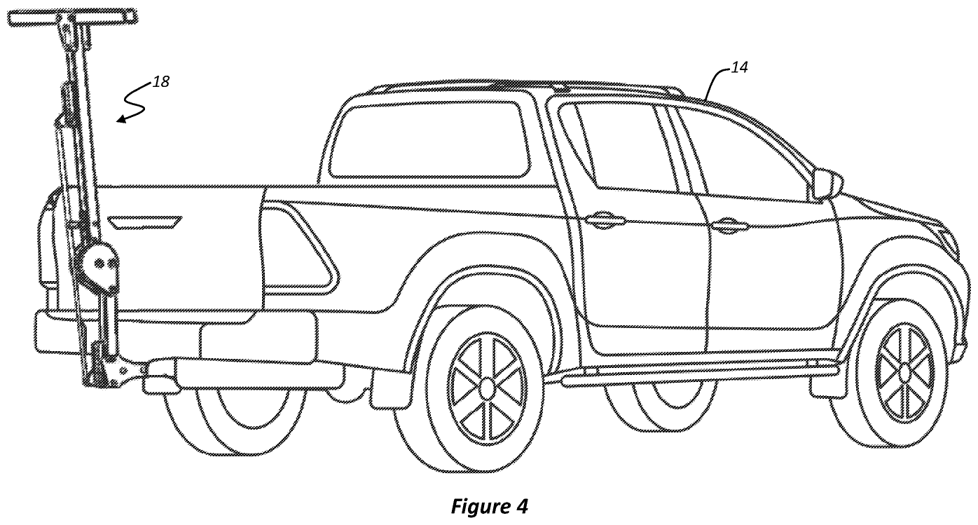

FIGS. 3 to 7 show a lifting device 18 according to an embodiment of the present invention. The device 18 is attached to the vehicle 14. The device 18 is in a tilted position in FIG. 3 and a raised position in FIG. 4.

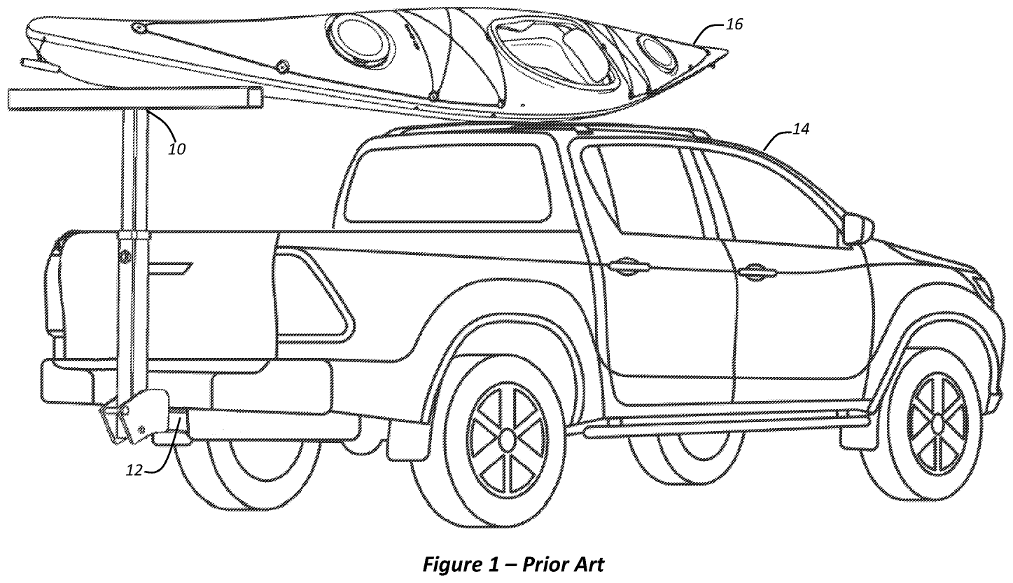

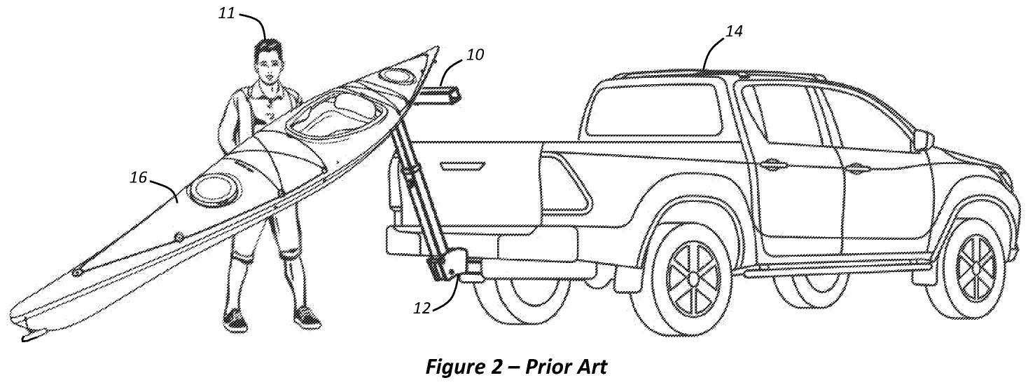

As can be seen in FIG. 3, the device 18 can be lowered to a much lower angle than the prior art lifting device 10 shown in FIGS. 1 and 2. The kayak 16 can be positioned on a trolley 22 to align with the device 18. Kayaks are heavy and long and therefore awkward to lift. The lower the kayak 20 has to be lifted, the easier it is to load onto the vehicle 14.

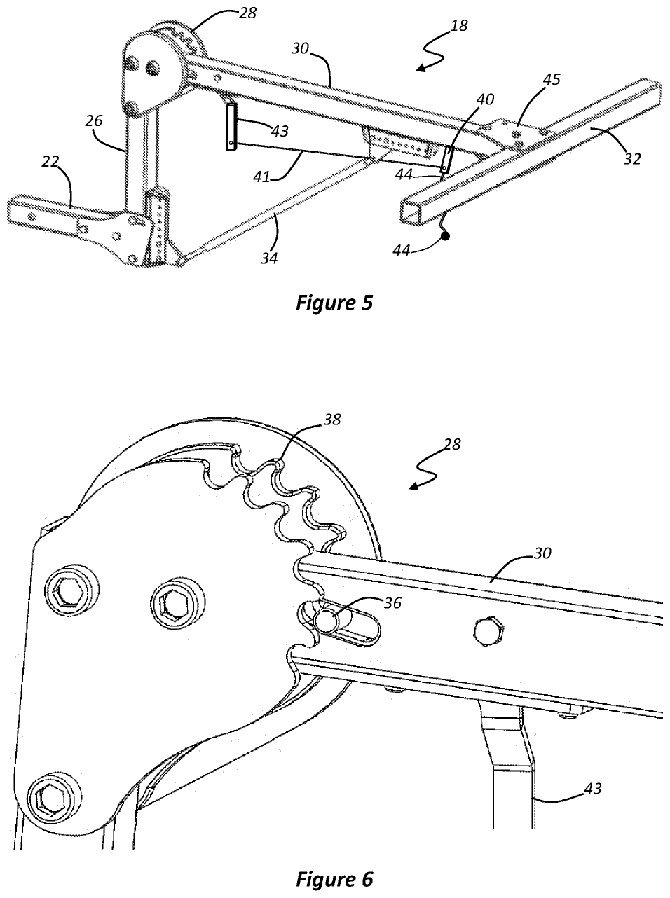

FIG. 5 shows the device 18 in more detail. The device 18 includes a tow-hitch bar 22 for insertion into tow-hitch receiver (not shown) on the vehicle 14. Alternatively, the device 18 could be attached to a tow ball (not shown).

The tow-hitch bar 22 is connected to a vertical bar 26. The vertical bar 26 is connected to a pivoting joint 28. The pivoting joint 28 is connected to the cross bar 30. The cross bar 30 is connected to the support bar 32. A strut 34 is connected between the vertical bar 26 and the cross bar 30.

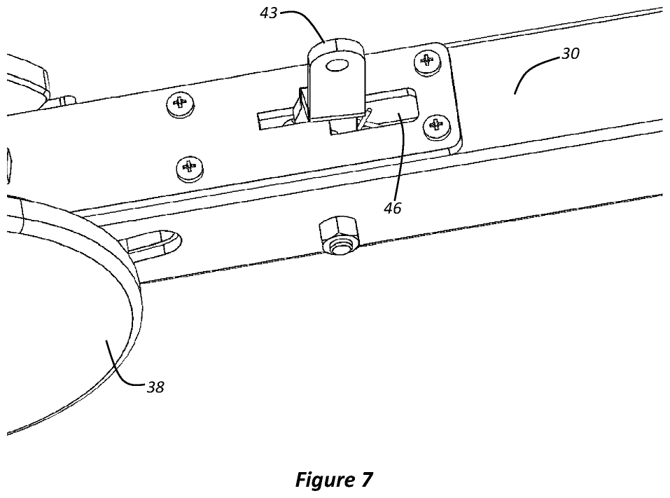

The pivoting joint 28 may be a ratchet cam, as shown in FIG. 6. The ratchet cam has a pin 36 which interfaces with teeth 38. The teeth 38 allow the pin 36 to slide down across them as the cross bar 30 is lowered. In order to raise the cross bar 30, a lever 40 is pulled to disengage the pin 36 from the teeth 38. When disengaged, the pin 36 assumes a retracted position 46, as shown in FIG. 7.

The strut 34 can be pneumatically or hydraulically powered to assist the cross bar 30 to be raised. The teeth 38 stop the strut 34 from raising the cross bar 30 when not intended by the user 11.

The user 11 can pull a cable 44 (see FIG. 5) on the first lever 40 which is connected by a line 41 to a second lever 43 to disengage the pin 36 from the teeth 38 and thereby allow the strut 32 to assist in raising the kayak 20 on the support bar 32.

In other embodiments of the invention, the ratchet cam 28 can be replaced with an electrically powered gear to automatically rotate the pivoting joint, a ratchet and pin system or any other form of locking mechanism.

In this way, the present invention requires less effort to mount and dismount the kayak on the roof of a vehicle than prior art lifting devices.

### CONCLUDING REMARKS

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A device for lifting an object onto the roof of a vehicle, the device comprising:
(a) a vertical bar connected to a tow-hitch bar on the vehicle;
(b) a cross bar connected to the vertical bar; and
(c) support bar connected to the cross bar for loading the object onto the roof of the vehicle,
wherein the device has:
i. a pivoting joint in the form of an adjustable ratchet cam between the vertical bar and the cross bar; and
ii. a strut between the tow-hitch bar and the cross bar to support the weight of the object as it is raised and lowered on the support bar.

2. (canceled)

3. The device of claim 1, wherein the ratchet cam has a pin which interfaces with teeth on the cam to lock the cam into one or more positions.

4. The device of claim 3, wherein the pin can be released by a lever connected to the pin.

5. The device of claim 4, wherein the lever is attached to a cable adapted to be pulled to release the pin.

6. The device of claim 3, wherein the ratchet cam can be released by a lever which is adapted to be pushed by the object as it passes over the support bar.

7. (canceled)

8. The device of claim 1, wherein support bar is adapted to pivot on a joint with the cross bar.
